(19) United States
(12) Patent Application Publication
(10) Pub. No.: US 2008/0296939 A1
(43) Pub. Date: Dec. 4, 2008

(54) METHODS AND SYSTEMS FOR PROVIDING COMFORT TO AN OCCUPANT OF A VEHICLE SEAT

(75) Inventors: Goran Bajic, Belle River (CA); Syed Iqbal, Tecumseh (CA); Dmitri Axakov, Waterloo (CA); Viktor Karch, Windsor (CA)

Correspondence Address: DOBRUSIN & THENNISCH PC, 29 W LAWRENCE ST, SUITE 210, PONTIAC, MI, 48342, US

(73) Assignee: W.E.T. Automotive Systems AG

(21) Appl. No.: 12/098,599

(22) Filed: Apr. 7, 2008

Related U.S. Application Data
(60) Provisional application No. 60/940,649, filed on May 29, 2007.

(51) Int. Cl. B60N 2/56

(52) U.S. Cl. 297/180.1

(57) ABSTRACT

A vehicle ventilation system, the system may include a generating source of compressed air; a receiver to receive and store the generated compressed air; a plurality of tubular members formed or extending through a cushion of the vehicle seat to a location proximate a contact surface of the seat, wherein the plurality of tubular members air in fluid communications with the receiver; and one or more valves for controlling the flow of air to the plurality of tubular members.

### CLAIM OF PRIORITY

The present application claims the benefit of the filing date of U.S. Provisional Application Ser. No. 60/940,649, filed May 29, 2007, hereby incorporated by reference.

### FIELD OF THE INVENTION

The present invention relates generally to systems and methods for providing comfort to an occupant of a vehicle seat, more particularly to systems and methods for providing comfort with a ventilation system and method.

### SUMMARY OF THE INVENTION

The present invention relates generally to systems and methods for providing comfort to an occupant of a vehicle seat. However, it should be appreciated that any of the ventilation configurations herein may be applied to seats other then vehicle seats. Furthermore, it is contemplated that the systems described herein may be incorporated into other devices used by individuals for provided comfort thereto.

### BRIEF DESCRIPTION OF THE DRAWINGS

FIGS. 1 to 2 provide illustrations and descriptions of a first aspect of the present invention.

FIG. 3a-b provides illustrations and descriptions of a second aspect of the present invention.

FIG. 4a-b provides illustrations and descriptions of a third aspect of the present invention.

FIG. 5 provides illustrations and descriptions of a fourth aspect of the present invention.

### DETAILED DESCRIPTION

The present invention provides various methods and systems for improving occupancy comfort to one or more occupants of a vehicle seat.

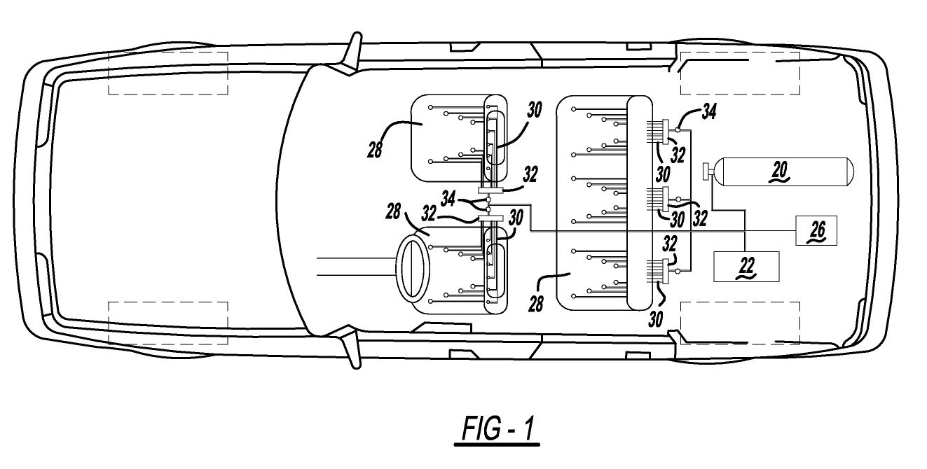

In a first aspect, referring to FIGS. 1 and 2, the present invention provides improved ventilation systems for vehicle seats. The improved ventilation system ensures guaranteed ventilation though highly compressed portions of the vehicle seat, such as during occupancy of the seat. This further ensures evaporation of perspiration of an occupant 24 of the seat.

The ventilation system includes a receiver 20 (e.g. a storage tank or otherwise) for receiving compressed air from an air compression source 22. The receiver 20 then selectively provides the compressed air to seats (particularly occupancy surfaces 28 of a seat) to provide improved comfort to an occupant 24.

The compressed air may be generated by an air compressor added to the vehicle system. In this configuration, it is contemplated that a pressure switch 26 may be provided to control air flow from the compressor pump to the receiver 20. The pressure switch 26/sensor acts to monitor the pressure within the receiver 20 and activate the pump when the pressure within the receiver 20 falls below a predetermined level. Alternatively, or in combination thereof, an existing compressor of a vehicle (such as a truck or otherwise) may be used to provide compressed air to the receiver 20. Other configurations are available.

The receiver 20 is in fluid communications with one or more seats which may have one or more occupancy surfaces 28 (e.g. single seat surfaces or benches). The fluid communications is achieved through a one or more, or a plurality, or even a network of tubing 30. Such tubing 30 may provide high pressure air ramp for the seat.

Optionally, the tubing 30 connects the receiver 20 to one or more manifolds 32 for distribution of the air throughout the seat. It is contemplated that there may be one manifold 32 per seat, or one manifold 32 per occupancy surface 28, or otherwise. In any configuration, in one preferred configuration the manifold 32 diverts the air from the receiver 20 to a plurality of areas throughout the seat. The manifold 32 may be located within the seat or externally.

Preferably, the manifold 32 diverts the air throughout the seat through a plurality of tubular members or openings formed through the seat. In one preferred configuration, a plurality of tubes 30 fluidly connect the manifold 32 to the occupancy surface 28 to provide a distribution of air flow across the seat. Even more preferably, the length and diameter of the tubes 30 are such that an even flow of air exist throughout the seat or air flow pattern.

The tubular members extend proximate to the surface of the seat. However, upon compression of the seat cushion through sitting or otherwise the flow of air is not compromised. Accordingly, the occupant 24 to the seat will not close off the airflow through the tube 30 by sitting in the seat. This advantage is achieved through the permeability of the exterior surface of the seat which allows air to flow therethough. However, other configurations are available to allow for continuous and substantial consistent airflow through the plurality of tubular members. The hydraulic resistance to the airflow the occupant can create when sitting over the tube opening is relatively small in comparison to the tube's own hydraulic resistance. Subsequently the airflow through the tube 30 in occupied zone is not significantly reduced, as it is in other known ventilation systems, but only reduced by a small fraction to that of the prior, unoccupied airflow. In order to provide the air flow rate evenly distributed at seating (contact) zone, the length of the tubes 30 need to be sufficiently the same, so long as they are of the same or similar diameter. However if some uneven distribution is required, then tubes 30 that may require larger flow may be shorter in length and/or their internal diameter may be larger.

The consistent airflow through the seat may be achieved through the design and configuration of the plurality of tubular members. For example, as shown in FIG. 2, to insure a consistent air flow pattern a shorter tubular member may include a thinner diameter than a longer tubular member. In any regard, preferably the airflow is balanced throughout the seat. In one configuration, it is contemplated that the largest diameter of the tubular members is approximately 1 mm or less.

The ventilation system further includes one or more valves 34 for controlling the flow of air from the receiver 20 to the manifold 32 and/or tubular members of the seat. The valves 34 may be activated through electrical, mechanical, pneumatic or other means. The valves 34 may also be electrically (e.g. remotely or otherwise) and/or manually controllable. In any configurations, there may be a switch 26 for each seat, occupant surface 28, manifold 32 or otherwise.

The tubular members preferably form a pattern of airflow through the occupant surface 28 of the seat, though it is contemplated that no particular pattern (e.g. non-symmetrical, non-geometric, or otherwise) is formed. The tubular member may extend through the seat cushion, the backrest, or both. The tubular members may extend through other components as well including arm rest, head rest or otherwise.

In a second aspect, referring to FIG. 2, the present invention provides an improved ventilation component for ventilation of an occupant 24 of a vehicle seat. In this aspect, it is contemplated that not only can the system provide ventilation to an occupant 24 to remove humidity but can also provide controlled application of air to provide other benefits such as massage therapy or otherwise. The flow of air can be predetermined or modified.

In one configuration, the system provides one or more manifolds 32 providing one or more, and preferably a plurality, of air flow paths to form a pattern of air ventilation through the occupant seat surface 28. The manifolds 32 may include a network of paths for movement of the air through the manifold 32 to a potential point of exit. Each potential point of exit may be inflatable and may include a valve or opening 38 for allowing air to flow through the point of exit (e.g. bag). In one configuration it is contemplated that the openings 38 formed through the point of exit are advantageously located such that the openings 38 are not closed upon occupancy of the seat.

In one configuration, the point of exit for the air through the manifold 32 forms an inflated pillow 36 like configuration. Each inflated portion may include an opening 38 for allowing air to flow therethrough or it may be completely closed to provide support or both. It is contemplated that each manifold 32 of the present invention may provide a different configuration of openings 38.

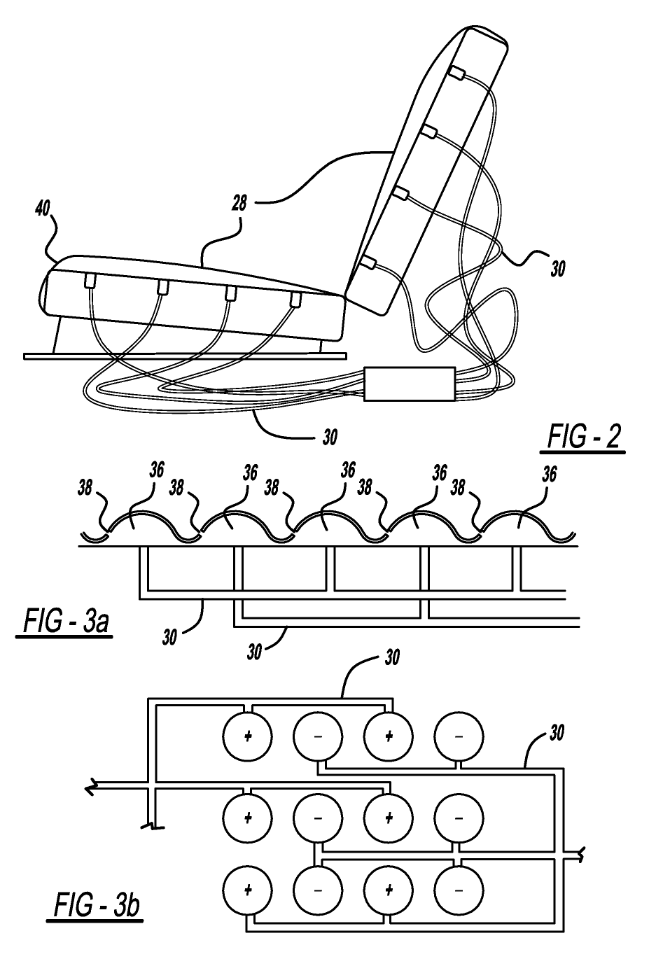

The manifolds 32 are fluidly connected to an air supply device, such as a low or high compression air sources. The air flow may be provided through one or more switches, which may include a three-way switch. In any configuration, optionally, the airflow through the switches and/or to the manifold 32 may be manually or automatically to provide desired benefits. In one configuration, the air may be continually provided for removal of humidity. In another configuration, the air may be provided in pulses to provide massage therapy. In an illustrative example of the massage, as shown in FIG. 3b, air is provided (shown as a +) to some pillows 36 and air is removed or allowed to be dissipated (shown as a −), providing a massage affect. Other configurations are contemplated. It should be appreciated that the flow of air to each of the manifolds 32 may be similar or different.

The manifolds 32 are advantageously placed below the surfaces of a seat cover 40 and optionally above or recessed within the cushion of the seat. In one configuration, each of the manifolds 32 forms a bag capable of inflation through the network of airflow paths, potential exit points, or otherwise.

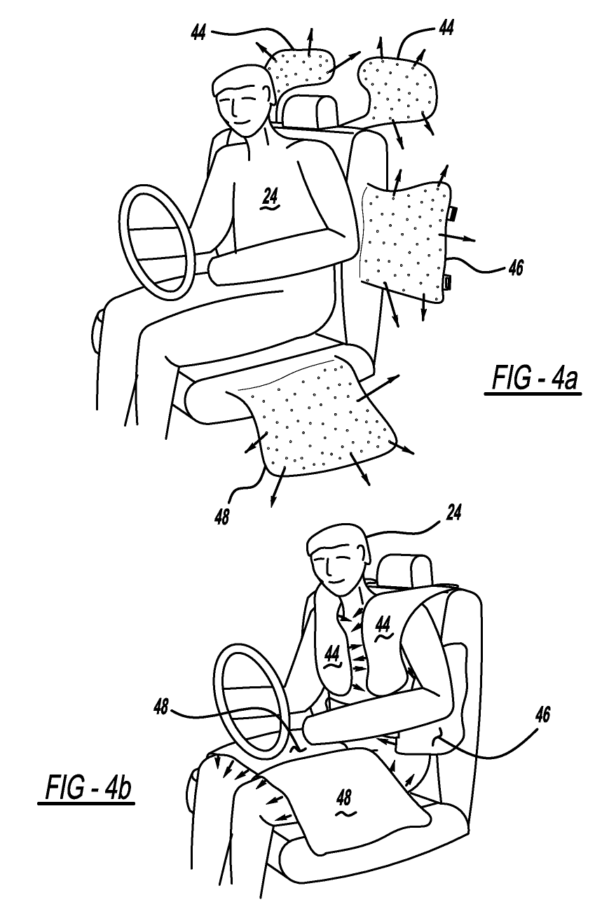

In a third aspect, referring to FIG. 4, the present invention provides one or more moveable members adapted to be placed over or proximate to an occupant 24 of a seat, or otherwise, to provide ventilation to an occupant 24. One or more, or even all, of the moveable members may be ventilated to provide air flow therethrough to the contact surface 28.

It is contemplated that the moveable members may comprise an item or device already incorporated in the design of a vehicle seat or otherwise. For example, the moveable member may comprise a portion of a seatbelt or restraint system of a vehicle. Such seatbelt systems may comprise a standard seat belt system, harness system (e.g. 4 point, 5 point or otherwise), or otherwise. Also, the moveable member may comprise a portion of the headrest, arm support or otherwise.

Alternatively, or in conjunction with the seatbelt restraint system described above, the moveable members may comprise additional features not typically formed with a vehicle. Such moveable members may be attached to a vehicle seat using any suitable means such as a hinge, fabric or otherwise. However, preferably the attachment configurations do not impede airflow to and through the moveable members. Additionally, these members may be removable, for example when they are not required during times when they are not needed or desired.

Preferably, the moveable members are ventilating at an occupant contact point or surface 28. Accordingly, the moveable members are ventilating to allow air to flow to or from a source 22 to or from the moveable members. The air from the air moving device may be treated, for example being filtered of hazardous gases or particles, being cooled, heated, dehumidified, humidified, or any combination thereof. Such ventilation through the moveable members may comprise any of the ventilation configurations described herein or otherwise. Similarly, the source of air may comprise any of the sources described herein or otherwise and may include any of the valves 34 or actuation configurations (e.g. automated or manual) described herein.

Examples of moveable ventilating components comprise moveable seat components configured to move into a position proximate and/or adjacent an occupant of the seat. Specific examples, as shown in FIGS. 4a and 4b, include ventilating collar components 44 attached to an upper or top portion of a seatback adapted to rotate over a chest portion of an occupant 24 of the seat. Another specific example comprises a ventilating lateral component 46 attached to a side portion of the seat back adapted to rotate to cover lateral and/or midsection portion of an occupant 24. Yet another example comprises a ventilating lateral seat component 48 attached to the side portion of the seat adapted to rotate over the leg portion of a seat occupant 24. In each of the specific examples, the moveable member moves (e.g. rotatable or otherwise) to cover a portion of the occupant 24 to provide ventilation thereof.

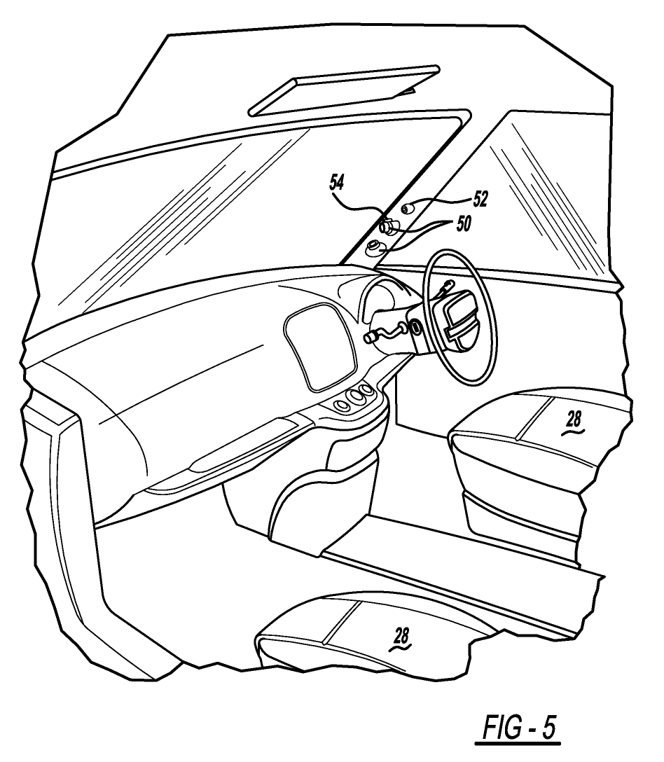

In a fourth aspect, referring to FIG. 5, the present invention provides a ventilation system adapted to seek out and cool specific areas within a vehicle. Advantageously, the system is configured to seek excessively hot or cold regions and provide ventilation thereto, which may be heated or cooled air.

For example, the system includes a temperature sensor for determining the temperatures at various regions within a vehicle. In one configuration, the sensor comprises an infrared sensor which is particularly configured to seek the surface temperatures over the surface area of an occupant 24. The sensor may be fixedly mounted or moveable (e.g. automatically or manually moveable). The sensor may scan the space angular segment similarly to as how infrared image sensors work or may incorporate multiple single direction infrared sensors grouped similarly to how the insect eye is built (e.g. each sensor may be responsible for registering a surface temperature in a specific direction). Also, a single one-directional sensor 52 may be arranged to scan the space in the assigned directional segment using servomotor or motors, moving the sensor itself or an oscillating mirror.

For example, the temperature sensor may sense the temperature of one or more of the occupant's body parts including head, shoulders, arms, chest, stomach, legs, feet or any other portion of the occupant 24. This may include drivers and passengers.

The system further includes one or more ventilating components 50 adapted to vent sensed surface 28 areas of the occupant 24, particularly surfaces areas deemed excessively hot or cooled. The ventilating components 50 may be located anywhere within the vehicle includes the interior of the vehicle roof, dash board, interior of the vehicle door or otherwise. The ventilating components 50 may comprise the standard vent of a vehicle or it may be in addition thereto or both.

The vents may be manually or automatically (e.g. motorized) moveable to vent a specific surface 28 area of an occupant 24. Also, the system may comprise a plurality of vents directed to different areas of an occupant surface 28. In this configuration, based upon the temperature sensor readings only specific ventilating components are activated to vent the surface 28 area of the occupant.

The one-directional infrared sensor 54, as discussed above, may be coupled with the ventilating component 50 (e.g. the nozzle or vent) so that both could change direction simultaneously. The components may be disposed at a permanent angle to one another (e.g. greater than 5 degrees). A permanent angle between the nozzle and the sensor may be beneficial, for example to compensate the parallax (equal to the point where both items are in the same spot). These scans may be alternating or simultaneous.

Optionally, the sensed information may be stored for a specific user. In this configuration, upon indication of the occupant 24, the ventilation components 50 may vent the occupant 24 based upon pre-sensed information. Also, the ventilation may be based upon other information such as exterior or interior temperature of the vehicle or otherwise. Additionally, vents may be movable, preferably in an angular manner to swipe hot zones by the airflow stream in a sequence preprogrammed or generated per specific sensor information. A plurality of stationary vents may be regulated by automatic valves 34, actuated by a control module. Valves 34 may be driven by any number of methods, including but not limited to mechanically, electrically, or pneumatically. It is contemplated that the control module may include a controller program. The controller program may contain a set of algorithms to optimize things such as cooling and heating efficiency, recognize the presence of a seat occupant 24, the size of the occupant 24, and distinguish an exposed seat surface from an occupied seat.

It is contemplated that any of the aspects, configurations, systems, methods or otherwise described herein may be combined to form other aspects of the present invention. Furthermore, it is contemplated that the features of each aspect described herein may be combined with other aspects described herein. Accordingly, the description herein should not be considered limiting in any aspect.

Also, it is contemplated that any of the aspects described herein may include a heating device in fluid communications with the ventilating components and/or placed over an occupant contact point. Similarly, it is also contemplated that any of the aspects described herein may include a cooling device, such as a thermoelectric device in fluid communications with the ventilating component. Still further, the ventilating components may alternatively or additionally be in fluid communications with the heat or cooling system of the vehicle.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A vehicle seat ventilation system, the system including:
a generating source of compressed air;
a receiver to receive and store the generated compressed air;
a plurality of tubular members formed or extending through a cushion of the vehicle seat to a location proximate a contact surface of the seat, wherein the plurality of tubular members air in fluid communications with the receiver; and
one or more valves for controlling the flow of air to the plurality of tubular members.

2. The ventilation system of claim 1, further comprising a pressure switch to control flow of the air between the generating source of compressed air and the receiver.

3. The ventilation system of claim 1, wherein the one or more valves are electrically controlled.

4. The ventilation system of claim 1, wherein the plurality of tubular members formed or extending through the seat are connected to the receiver through one or more high pressure air ramps.

5. The ventilation system of claim 5, wherein the high pressure air ramps comprises one or more manifolds for directing air from the receiver to one or more occupant surfaces.

6. The ventilation system of claim 1, wherein the generating source of compressed air comprises an air pump.

7. The ventilation system of claim 6, wherein the air pump comprising an existing source of compressed air from the vehicle.
